(19) United States
(12) Patent Application Publication
(10) Pub. No.: US 2026/0289667 A1
(43) Pub. Date: Sep. 24, 2026

(54) System and method for real-time valuation and exchange of social media influence metrics via an online or software-based securities platform

(71) Applicant: Saud A Y B E Aljenaie, Jada (KW)

(72) Inventor: Saud A Y B E Aljenaie, Jada (KW)

(21) Appl. No.: 19/326,722

(22) Filed: Sep. 11, 2025

Related U.S. Application Data
(63) Continuation of application No. 19/085,671, filed on Mar. 20, 2025.

(51) Int. Cl. G06Q 40/04; G06Q 30/0201; G06Q 50/00

(52) U.S. Cl. CPC G06Q 40/04; G06Q 10/40; G06Q 30/0206

(57) ABSTRACT

A system and method for creating and managing tradable securities linked to the real-time influence metrics of social media personalities. The system aggregates data from multiple social media platforms, analyzes this data using machine learning algorithms, and generates an influence valuation score. This valuation score, incorporating follower counts, engagement growth rates, and merchandise sales, determines the initial share price for the influencer's security. A market dynamics processor then adjusts the share price based on real-time market activity and overall investor sentiment. To ensure regulatory compliance, a compliance gateway uses natural language processing to interpret securities regulations and automatically generate jurisdiction-specific smart contracts, ensuring adherence to financial regulations. These securities are traded on a blockchain-enabled platform to provide transparent secondary market trading and data immutability. This system enables investors to directly invest in the success of influencers, creating a new asset class while offering influencers alternative monetization strategies.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of.

### Listing of the Prior Art

The following references might be to be related to the disclosed subject matter:
U.S. Pat. No. 5,809,484 by the Human Capitol Resources, Inc. (issued Sep. 15, 1998) discloses “method and apparatus for funding education by acquiring shares of students future earnings;”
U.S. Pat. No. 10,672,012 by IBM® (issued Jun. 2, 2020) discloses a “brand personality comparison engine;”
U.S. Pat. No. 10,878,500 by Flair, Inc. (issued Dec. 29, 2020) discloses “systems and methods for managing a talent based exchange;”
U.S. Pat. No. 11,763,387 by Sharematter, Inc. (issued Sep. 19, 2023) discloses “system and method for the valuation and securitization of content;”
US20020077961A1 by Eckert et al. (published Jun. 20, 2002) discloses “performer income trading system and method;”
US20050080705A1 by Chaganti (published Apr. 14, 2005) discloses “selling shares in intangible property over the internet;”
US20200294099A1 by Angelink, Inc. (published Sep. 17, 2020) discloses “computerized systems and methods for managing crowdfunding campaigns;”
US20200043055A1 by Boodle, Inc. (published Feb. 6, 2020) discloses “systems and methods for intelligent peer-to-peer fundraising campaign management;” 2021; patented Jul. 23, 2024) discloses an “apparatus and method for an electronic marketplace for creative works;” and
US20230394506A1 by Captiv8, Inc. (published Dec. 7, 2023) discloses “systems and method for identifying, tracking, and managing a plurality of social network using having predefined characteristics.”

See the Information Disclosure Statements (IDS) of record.

### Background of the Invention

The concept of securitizing human capital and performance metrics has evolved significantly in financial technology, with prior systems focusing on tradable instruments tied to individual talent or content value. Early innovations, such as U.S. Pat. No. 10,878,500 (Flair, Inc.), introduced a talent-based exchange where tradable stocks represented insured earning potential of individuals, encoded as digital objects on distributed ledgers. While this system enabled liquidity for talent-backed assets, it relied on static insurance underwriting rather than dynamic performance metrics, failing to account for real-time fluctuations in market demand or digital engagement.

Subsequent developments, including U.S. Pat. No. 11,763,387 (Sharematter, Inc.), expanded securitization to content catalogs, allowing investors to trade shares in creative works through cloud-based platforms. However, this approach treated content as fixed assets without addressing the volatility of creator-specific metrics or integrating multi-platform social data. Parallel efforts in US20020077961A1 (Eckert et al.) established securities tied to performers' prospective income, using actuarial models to estimate contingent earnings from athletes or entertainers. While groundbreaking in linking financial instruments to human performance, these systems employed conventional valuation frameworks disconnected from digital-native metrics like follower growth or engagement velocity.

Specialized platforms such as US20090233716A1 (Cash) demonstrated domain-specific applications, enabling investors to fund poker players' tournament entries in exchange for a percentage of winnings. This model highlighted the market potential for fan-driven investments but remained confined to manual valuation processes and single-industry use cases, lacking scalable algorithmic pricing mechanisms or cross-platform data aggregation.

Critically, these prior systems exhibited three limitations: (1) dependence on static insurance models or retrospective financial analysis rather than real-time digital biomarkers; (2) absence of multi-platform social metric integration for dynamic valuation; and (3) manual compliance processes ill-suited for global securities regulations. The present invention resolves these gaps through a novel synthesis of machine learning-driven performance analytics, blockchain-enabled transaction transparency, and automated regulatory adaptation, creating the first end-to-end marketplace where social influence converts directly into liquid financial instruments.

### SUMMARY OF THE INVENTION

In light of the foregoing, this specification discloses a system and method for the automated, real-time valuation, issuance, and exchange of securities based on social media influence metrics. The system uniquely integrates dynamic data from multiple social media platforms with securities trading mechanisms, facilitated by a proprietary, multi-parametric valuation algorithm, a real-time market dynamics processor, and a secure, transparent blockchain infrastructure. This combination, coupled with an automated regulatory compliance gateway, overcomes the limitations of existing talent-based exchanges and content securitization platforms by providing dynamic valuation, transparent trading, and automated compliance. Key improvements over the prior art include: (1) A machine learning-driven valuation model utilizing both static and dynamic engagement metrics across multiple platforms to generate a real-time influence valuation score; (2) A market dynamics processor that adjusts security prices based on real-time market demand, influencer-specific events, and calculated volatility indices, reflecting the dynamic nature of social media influence; and (3) An automated regulatory compliance gateway employing natural language processing to interpret jurisdictional securities regulations and generate smart contracts to enforce compliance, thereby enabling seamless, cross-border transactions.

In one embodiment, the system architecture comprises interconnected modules that function in coordination to enable the valuation, trading, and regulatory compliance of influencer-based securities. The first module, the Influencer Valuation Engine (detailed in FIG. 2), ingests data from multiple social media platforms to calculate an initial share price based on follower counts, engagement metrics, and sales data. The second module, the Market Dynamics Processor (illustrated in FIG. 3), adjusts the initial share price based on real-time market demand, influencer-specific events, and calculated volatility indices, leveraging a combination of sigmoid and non-sigmoid function analysis. The third module, the Regulatory Compliance Gateway (depicted in FIG. 4), ensures adherence to relevant securities regulations by employing natural language processing to interpret jurisdictional requirements and automatically generating smart contracts to govern transaction execution. These smart contracts are then applied before a blockchain transaction record is created (as shown in FIG. 6) and presented to the user on the User Interface (as shown in FIG. 5).

In other embodiments, disclosed may be A system and method for real-time valuation of social media influence metrics through a multi-platform data normalization engine that resolves API-driven interoperability conflicts across heterogeneous social networks. The system employs a machine learning model trained on dynamic engagement patterns to generate influence scores, coupled with a market dynamics processor that mitigates computational latency in high-frequency trading via hybrid sigmoid/non-sigmoid volatility analysis. A regulatory compliance gateway automates jurisdictional adaptation using NLP-based regulation parsing, enabling cross-border transactions through smart contracts that enforce real-time compliance checks. Blockchain integration provides tamper-evident transaction records addressing double-spending risks in influencer securities markets.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is high-level block diagram illustrating some of the key components of the system;

FIG. 2 is a process flow diagram for the Influencer Valuation Engine;

FIG. 3 is an example market dynamics algorithm;

FIG. 4 is a diagram of the operation of the Regulatory Compliance Gateway;

FIG. 5 is an example user interface diagram;

FIG. 6 is an example blockchain transaction record; and,

FIG. 7 is a system data flow diagram.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

This is a specification of a system and method for real-time valuation and exchange of social media influence metrics via an online or software-based securities platform. The specific details of the system are disclosed in connection with the appended FIGURES.

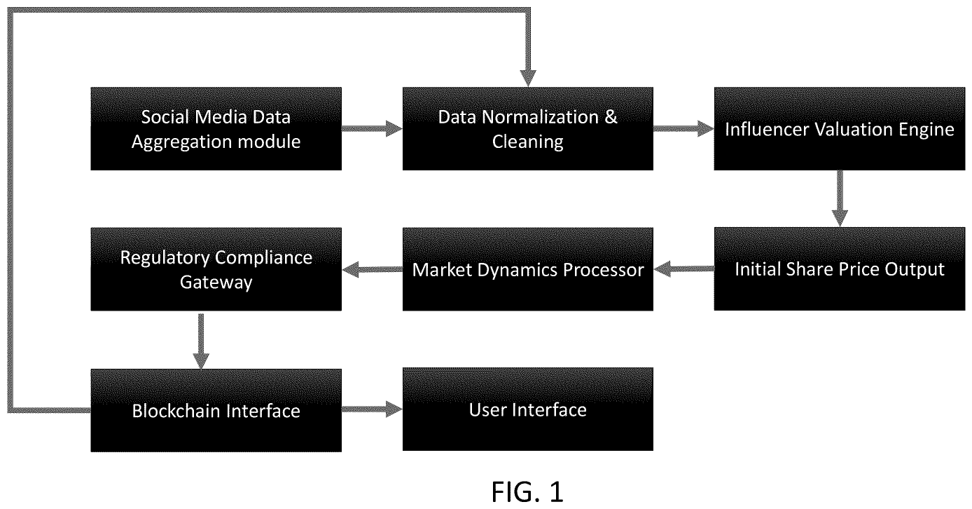

FIG. 1 is high-level block diagram illustrating some of the key components of the system. This block diagram provides a visual representation of the system architecture, making it easier to understand the relationships between the different components. The inclusion of key functions within each module clarifies the purpose of each block.

As shown in FIG. 1, the system includes a Social Media Data Aggregation Module. This block represents the collection of data from various social media platforms (YouTube, TikTok, Instagram, etc.) via their respective APIs. The module then normalizes and cleans the collected data. The system also preferably includes an Influencer Valuation Engine. Suitably, This block uses the cleaned data to calculate an initial share price for each influencer, using the follower count, engagement growth rate, and sales metrics. The system may also include a Market Dynamics Processor. This module takes the initial share price and adjusts it based on real-time market data and calculated volatility. Another component of the system may be a Regulatory Compliance Gateway. In a preferred embodiment, this module processes securities regulations using Natural Language Processing (NLP) and generates smart contracts to ensure compliance. In one version, the system may include a Blockchain Inter face. This module records transactions on a distributed ledger, ensuring data immutability. Finally, the system may include a User Interface. Preferably, this module presents the data to the user through an interface with real-time price updates, trading, and portfolio management functionality. In some versions, an image or read-out of the podcaster share prices provided will be a visual element in this module. As shown, data from the Blockchain Interface may loop back into the Data Normalization & Cleaning to show how the information presented on the user interface can or should modify the data normalization process.

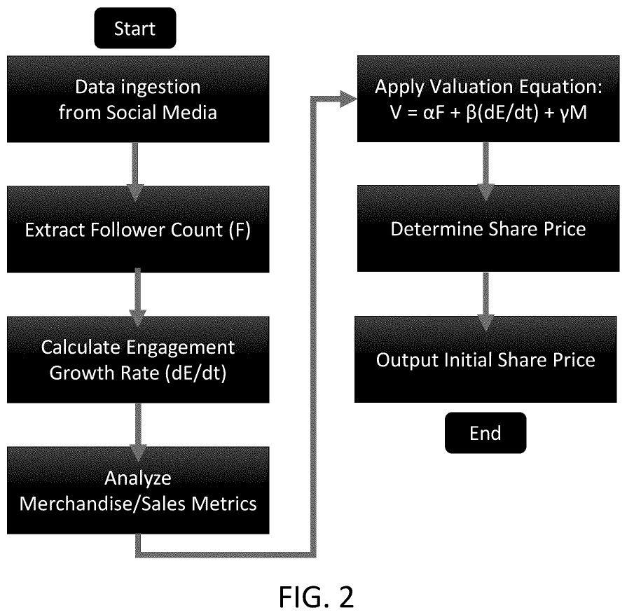

FIG. 2 is a process flow diagram for the Influencer Valuation Engine. The first step is START: The process begins. The second step may be Data Ingestion from Social Media Platforms: The system collects data from various social media platforms using their APIs. The third step may be Extract Follower Count (F): The number of followers is extracted from the data. The fourth step could be Calculate Engagement Growth Rate (dE/dt): The rate at which engagement is growing is calculated. The fifth step in the flow may suitably be Analyze Merchandise/Sales Metrics (M): Data related to merchandise sales or other relevant sales metrics is analyzed. The sixth step may be Apply Valuation Equation: The example valuation equation V=αF+β(dE/dt)+γM is applied to determine the initial valuation, V. The seventh step may be Determine Initial Share Price: Based on the valuation, an initial share price is determined. The eighth step may be Output Initial Share Price: The initial share price is outputted and sent to the Market Dynamics Processor. The final step may be END: The process ends.

In one embodiment, data ingestion from social media platforms involves collecting and importing data from various social media sources for analysis and processing. This process may be considered crucial for businesses and researchers looking to gain insights from social media activity. There are several example approaches to ingesting social media data. One approach is API Integration where many social media platforms provide APIs that allow developers to access and retrieve data programmatically. For example, the Twitter or X Streaming API can be used to collect tweet events in real-time. Another approach may be Batch Ingestion where this method involves collecting data in discrete chunks at specific intervals, such as daily or weekly. It's suitable for scenarios where real-time processing isn't critical. A third example approach includes Stream Ingestion (aka real-time ingestion) where data is processed continuously as the data is generated. A fourth example approach includes Incremental Ingestion where a focus is placed on capturing only new or changed data since the last ingestion cycle such that a goal of reducing time and resources for data transfers is attainable.

Under any approach or a combination of all the approaches, key components of data ingestion systems include:
Extract, Transform, Load (ETL) processes
Event-driven ingestion mechanisms
Data normalization and cleaning tools
Storage solutions like data warehouses or data lakes
   By leveraging these approaches and tools, businesses and researchers can effectively collect and analyze social media data to gain valuable insights into user behavior, trends, and engagement metrics.

The process of extracting the follower count (F) from social media platforms, such as Instagram, can be implemented using available tools and APIs.

The process of calculating the Engagement Growth Rate (dE/dt) is mathematical and may involve measurement of the change in engagement over time. One example method to calculate this rate involves the steps of:
1. Choose a time period for measurement (e.g., weekly or monthly).
2. Calculate the engagement rate (ER) at the start and end of this period.
3. Use the following formula to determine the growth rate:

$$Engagement Growth Rate ( dE / dt ) = ( ER\_end - ER\_start ) / Time\_period$$

Analyzing Merchandise/Sales Metrics (M) is a step in evaluating the effectiveness of influencer marketing campaigns. Here are some example aspects to consider when analyzing these metrics: Sales and Revenue Tracking; Return on Investment (ROI); Customer Acquisition Cost (CAC); Promo Code Usage; Website Traffic and Behavior

To apply the valuation equation V=αF+β(dE/dt)+γM for an influencer's stock, we need to consider the components:
1. F (Follower Count): This is a straightforward metric extracted from the influencer's social media profiles.
2. dE/dt (Engagement Growth Rate): This can be calculated using the formula:

$$( ER\_end - ER\_start ) / Time\_period$$

$$Where ER ( Engagement Rate ) = {( Total engagements on a post / Reach of that post )}^{*} 100$$

3. M (Merchandise/Sales Metrics): This involves analyzing various factors:
   Direct sales attributed to the influencer using unique promotional codes or affiliate links
   Conversion rates
   Return on Investment (ROI) or Return on Ad Spend (ROAS)
   Customer Acquisition Cost (CAC)
   Website traffic and behavior metrics
      The coefficients α, β, and γ are weighting factors that determine the relative importance of each component in the overall valuation.
      To calculate the final valuation:
1. Determine F by extracting the current follower count.
2. Calculate dE/dt by measuring the change in engagement rate over a specific time period.
3. Analyze M by combining various merchandise and sales metrics into a single value.
4. Apply the weighting factors α, β, and γ to each component.
5. Sum the weighted components to get the final valuation V.
   This valuation can then be used to determine an initial share price for the influencer's stock.

To determine the initial share price for an influencer's stock, we need to consider the valuation (V) calculated using the equation V=αF+β(dE/dt)+γM. Once we have this valuation, we can determine the initial share price by dividing the total valuation by the number of shares to be issued.

A step-by-step process may include:
1. Calculate the total valuation (V) using the equation.
2. Decide on the number of shares to be issued. This could be based on the company's capitalization strategy or market norms.
3. Divide the total valuation by the number of shares:

$$Initial Share Price = \$1 , 000 , 000 / 100 , 000 = \$10 per share$$

For example, if the total valuation is $1,000,000 and the company decides to issue 100,000 shares:

$$Initial Share Price = Total Valuation ( V ) / Number of Shares Issued$$

It may be important to note that this initial price should be set above the nominal value of the shares, which is typically very low (e.g., $0.01 per share).
When determining the initial share price, consider:
1. Market comparisons: Look at similar influencer businesses to gauge appropriate pricing.
2. Future growth potential: Factor in projected earnings and audience growth.
3. Investor expectations: Ensure the price is attractive to potential investors while fairly representing the business's value.
   Suitably, it should be noted that the initial share price is a starting point and, after that, the market may ultimately determine the true value of the shares once they begin trading.

The initial share price may be output on the user interface.

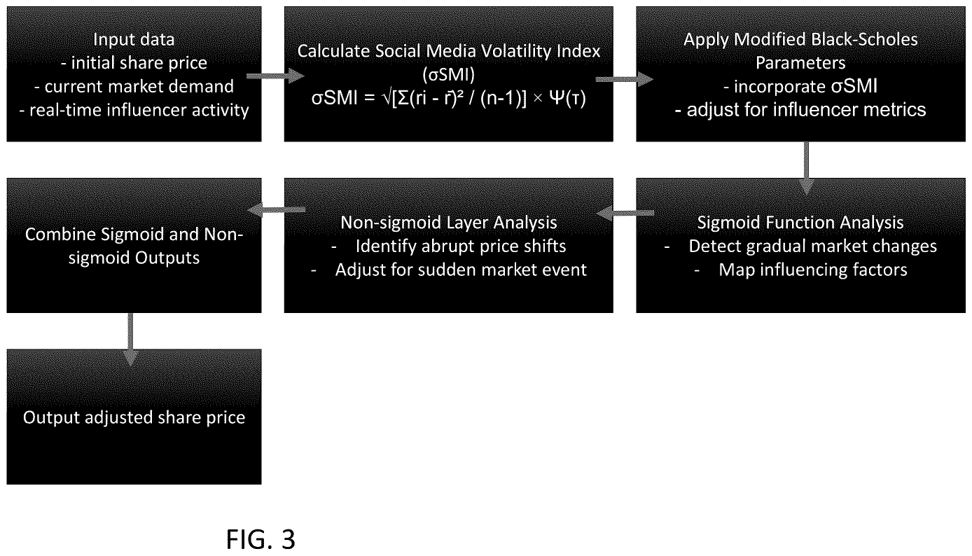

FIG. 3 illustrates the Market Dynamics Processor Algorithm, which is designed to adjust share prices based on real-time market conditions and social media influences. The process begins with input data, including the initial share price, current market demand, and real-time influencer activity. The algorithm then calculates the Social Media Volatility Index (σSMI) using a formula that considers the variance in engagement rates and a time decay function specific to influencer relevance cycles.

Next, the algorithm applies modified Black-Scholes parameters, incorporating the OSMI and adjusting for influencer-specific metrics. This step adapts traditional financial models to the unique characteristics of social media-driven markets. The process continues with a sigmoid function analysis to detect gradual market changes and map influencing factors, followed by a non-sigmoid layer analysis to identify abrupt price shifts and adjust for sudden market events. These two analyses are then combined to provide a comprehensive view of market dynamics.

Finally, the algorithm outputs an adjusted share price that reflects both the gradual trends and sudden changes in the market, taking into account the complex interplay between social media sentiment, influencer performance, and traditional market factors. This dynamic pricing approach ensures that the share price remains responsive to the rapidly changing landscape of social media influence and market demand.

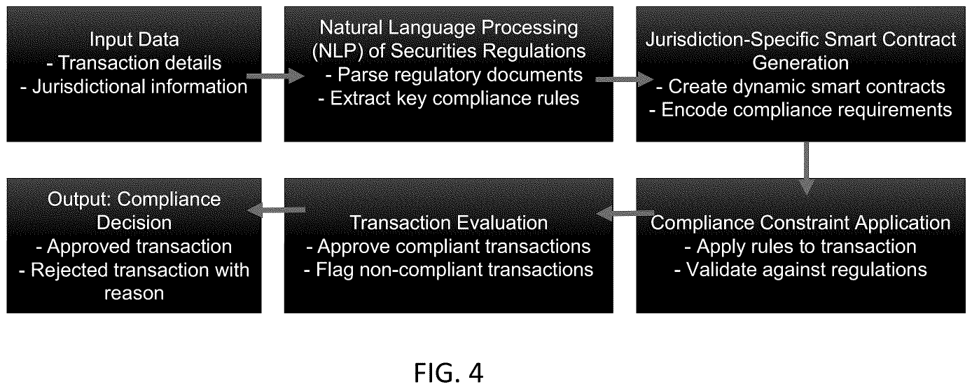

FIG. 4 illustrates the operation of the Regulatory Compliance Gateway, a critical component of our innovative system for trading influencer-based securities. The diagram depicts a streamlined process that begins with the input of transaction details and jurisdictional information. This data is then processed through a Natural Language Processing (NLP) module, which analyzes and interprets relevant securities regulations from various jurisdictions. The NLP output informs the generation of jurisdiction-specific smart contracts, which encode the necessary compliance requirements. These smart contracts are then applied to the transaction, validating it against the applicable regulations. The system evaluates the transaction, approving those that meet all compliance criteria and flagging those that do not. Finally, the gateway outputs a compliance decision, either approving the transaction or rejecting it with a detailed explanation. This automated process ensures real-time regulatory compliance across different jurisdictions, significantly reducing the risk of non-compliance while increasing the efficiency of cross-border transactions in the dynamic world of influencer-based securities trading.

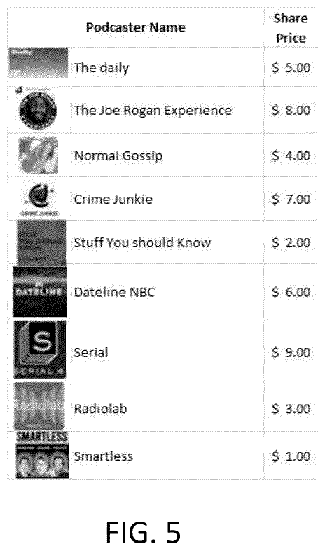

FIG. 5 is an example user interface diagram FIG. 5 depicts a user interface for displaying real-time share prices of influencer-based securities, specifically showcasing a drop-down menu for podcast-related stocks. The interface presents a list of podcasters, each associated with their current share price. This dynamic display allows users to quickly view and compare the market values of different podcast influencers. The real-time nature of the interface means that price fluctuations are immediately reflected, providing up-to-date information for potential investors or traders. This visual representation serves as a crucial component of the system's user interface, enabling easy access to market data and facilitating informed decision-making in the rapidly evolving landscape of influencer-based securities trading.

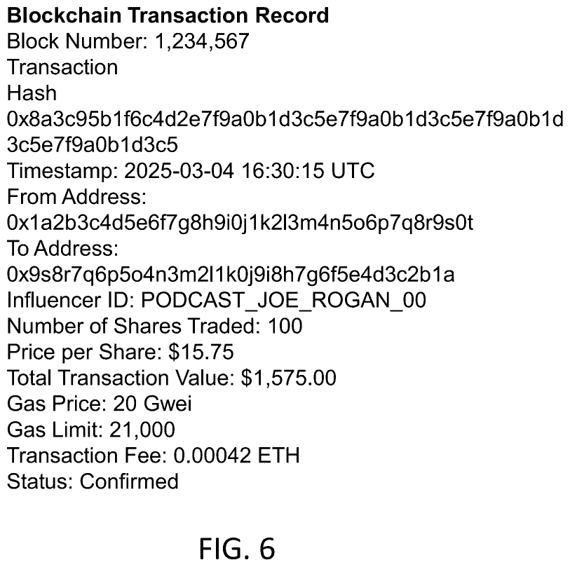

FIG. 6 illustrates a detailed blockchain transaction record for a trade of influencer-based securities. The record is timestamped Mar. 4, 2025, at 16:30:15 UTC, aligning with the current date. It includes essential elements such as the block number (1,234,567), a unique transaction hash, and the blockchain addresses of both the buyer and seller. The transaction specifically involves the trading of 100 shares of “PODCAST_JOE_ROGAN_001” at $15.75 per share, totaling $1,575.00. The figure also displays Ethereum-specific details like gas price and limit, with a transaction fee of 0.00042 ETH. This comprehensive record demonstrates how the system leverages blockchain technology to ensure transparency and traceability in all trades of influencer-based securities, providing a clear audit trail of each transaction

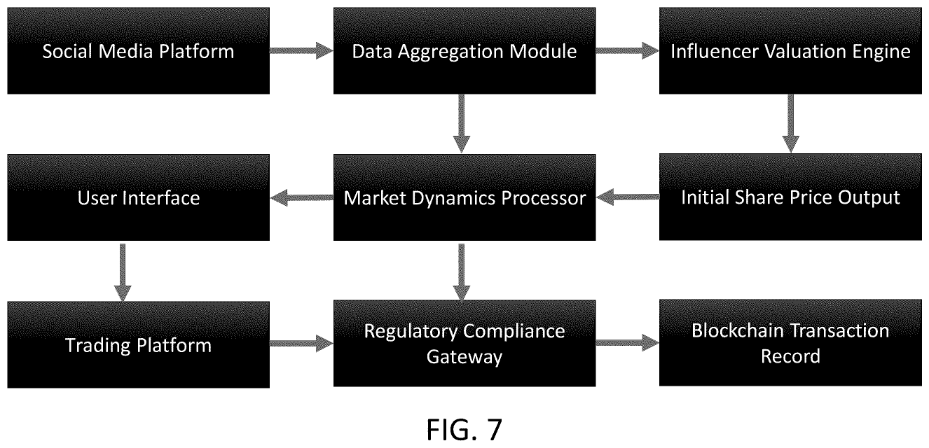

FIG. 7 is a system data flow diagram. FIG. 7 illustrates a comprehensive system data flow diagram for our influencer stock trading platform. The process begins with data collection from various social media platforms, which is then aggregated and processed by the Data Aggregation Module. This consolidated data feeds into the Influencer Valuation Engine, which calculates initial share prices based on factors such as follower count, engagement rates, and merchandise sales metrics. The Market Dynamics Processor then adjusts these prices in real-time, accounting for market trends and sudden events. This information is displayed to users through the User Interface, which provides real-time market data, charts, and trading tools. When a user initiates a trade via the Trading Platform, the transaction is first validated by the Regulatory Compliance Gateway to ensure adherence to relevant securities regulations. Finally, approved transactions are recorded on the blockchain, creating an immutable and transparent record of each trade. This interconnected system enables efficient, compliant, and data-driven trading of influencer-based securities.

### Example One—John Doe Podcast

A hypothetical podcase called “The John Doe Podcast” may provide one illustrative example. First, the Social Media Data Aggregation Module collects data from Spotify® (a platform where the podcast is hosted), YouTube (where video clips are often published), Twitter (now X) (where the John Doe frequently engages), and other relevant social media platforms via their respective APIs. This data includes follower/subscriber counts, like/dislike ratios, comment volume, viewership statistics, and keyword mentions. Next, the Influencer Valuation Engine processes this data, applying a proprietary machine-learning algorithm to calculate the podcast's influence valuation. This calculation incorporates factors such as the base subscriber count on Spotify and YouTube, the rate of subscriber growth over the past quarter, the average views per video clip, and the sentiment analysis of Twitter (now X) mentions related to the podcast. Based on this valuation, an initial share price is determined—for instance say $8.00 per share. The Market Dynamics Processor then continuously monitors market activity and adjusts the share price in real-time. If there is a controversial episode, for instance, causing a spike in negative Twitter (now X) sentiment and a drop in viewership on YouTube, the processor might lower the share price to $7.50. Conversely, if John Doe announces a high-profile guest leading to increased subscriptions and positive social media buzz, the processor could raise the share price to $8.50. When a user decides to purchase shares of “The John Doe Podcast” stock through the trading platform, the Regulatory Compliance Gateway steps in. Based on the user's location and the applicable securities regulations, the gateway generates a smart contract that ensures the transaction complies with all relevant rules and requirements. Once the transaction is validated and executed, it is immutably recorded on the blockchain, providing a transparent and secure record of the trade. This entire process, from data aggregation to blockchain recording, occurs seamlessly and automatically, allowing investors to trade shares of “The John Doe Podcast” and other influencer-based securities with ease and confidence.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

1. A system for generating and trading securities based on social media influence metrics to mitigate computational latency in high-frequency influencer markets, comprising:
a. A multi-platform data normalization engine configured to collect heterogeneous data from a plurality of social media platforms via their respective application programming interfaces (APIs), resolve API-driven interoperability conflicts across said platforms, and convert non-uniform data including follower counts, engagement metrics, sentiment factors and sales data into a standardized universal format;
b. An influencer valuation engine configured to calculate an initial share price for an influencer security based on the standardized data, utilizing a machine learning algorithm to determine an influence valuation score that weights follower counts, engagement metrics, monetization channels and sales data, and outputting the initial share price;
c. A market dynamics processor configured to adjust the initial share price in real-time based on market demand, influencer-specific events, and calculated volatility indices adjusted for influencer relevance cycles to mitigate high-frequency trading latency, utilizing a hybrid combination of sigmoid function analysis to detect gradual market shifts and non-sigmoid function analysis to identify abrupt price shifts from sudden market events;
d. A regulatory compliance gateway configured to:
i. dynamically process jurisdictional securities regulations and regulatory documents using natural language processing (NLP) to parse and interpret jurisdictional requirements;
ii. automatically generate jurisdiction-specific smart contracts to ensure real-time compliance; and
iii. implement the generated smart contracts to determine if a proposed transaction is compliant with the processed securities regulations prior to execution; and
e. A blockchain interface configured to record validated transactions on a distributed ledger, providing transparent tamper evident secondary market trading.

2. A system for the valuation and exchange of influencer-based securities, comprising:
a. A multi-platform data normalization engine configured to collect heterogeneous, non-uniform data from a plurality of social media platforms via their respective application programming interfaces (API), resolve API-driven interoperability conflicts across said platforms, and convert the non-uniform data, including static follower counts, sales data and dynamic engagement metrics, into a standardized universal format;
b. An influencer valuation engine configured to generate an initial share price for an influencer based on the standardized data, wherein the valuation engine applies weighting factors to the follower counts, engagement metrics, and sales data to determine an influence valuation score;
c. A market dynamics processor configured to dynamically adjust the initial share price, the market dynamics processor analyzing data using a Sigmoid Function Analysis to detect gradual market changes and map influencing factors and a Non-Sigmoid Layer Analysis to identify abrupt price shifts and adjust for sudden market events; and
d. A regulatory compliance gateway including a Natural Language Processing (NLP) module to process jurisdictional regulations and a smart contract generator to automatically generate smart contracts that implement relevant compliance rules and govern trade execution and determine whether a trade is compliant, wherein the generation of the smart contracts includes automated deployment of rules and requirements.

3. A method for automatically generating and exchanging securities based on social media influence metrics, comprising the steps of:
a. Collecting heterogeneous, non-uniform data from multiple social media platforms using their respective application programming interfaces (APIs) and resolving API-driven interoperability conflicts across said platforms to convert the non-uniform data, including follower counts, engagement metrics, sentiment factors, and sales data, into a standardized universal format;
b. Calculating an initial share price for an influencer security using a machine learning algorithm applied to the standardized data, the algorithm using weighting factors to apply significance to both static and dynamic engagement metrics and monetization channels in determining an influence valuation score, wherein the influence valuation score determines the initial share price;
c. Adjusting the initial share price in real-time based on market demand, influencer-specific events, and calculated volatility indices adjusted for influencer relevance cycles using a combination of sigmoid and non-sigmoid function analysis to identify abrupt price shifts from sudden market events, to determine a final share price;
d. Automatically generating, using a Natural Language Processing (NLP) module, a jurisdiction-specific smart contract based on the current legal jurisdiction by parsing interpreting applicable securities regulations and regulatory documents to determine if a proposed transaction involving the final share price is compliant with the relevant securities regulations for both the buyer and seller;
e. Executing the transaction if it is compliant and implementing the generated smart contract to govern the execution; and
f. Recording the validated transaction on a distributed ledger, providing transparent, tamper-evident secondary market trading for the influencer security.
